(19) United States
(12) Patent Application Publication
(10) Pub. No.: US 2020/0255073 A1
(43) Pub. Date: Aug. 13, 2020

(54) Motorized Transport Vehicle

(71) Applicant: Garlock Equipment Company, Plymouth, MN (US)

(72) Inventors: Jacob Daniel Carlson, Stacy, MN (US); Lance Richard Hartmann, Lakeville, MN (US)

(21) Appl. No.: 16/784,381

(22) Filed: Feb. 7, 2020

Related U.S. Application Data
(60) Provisional application No. 62/802,731, filed on Feb. 8, 2019.

(51) Int. Cl. B62D 51/00; B60L 50/62; B60K 1/04; B60K 7/00

(52) U.S. Cl. CPC B62D 51/008; B60L 50/62; B60L 2200/40; B60K 7/0007; B60K 1/04

(57) ABSTRACT

A motorized wheel is connected to a single boom pivotally connected to a body having front wheels. The body carries a power supply for the motorized wheel in the form of batteries and a generator. A work piece is removably carried on the body by extending across horizontal supports or in a tray having pivot extrusions slideably received on attachment brackets while support extrusions abut with the horizontal supports. The body includes first and second frames including first, second and third legs extending at obtuse angles from each other and a handle extending between the third legs. The body further includes support components holding the first and second frames in a spaced, parallel relation and supporting the batteries and the generator. A sulky is slideably connected to the single boom and upon which a worker stands.

### BACKGROUND

A motorized transport vehicle, especially for handling materials on flat roof surfaces, is shown and described.

Conventional transport vehicles for handling materials on flat roof surfaces have experienced considerable market success. A first type of transport vehicle includes a body having front wheels driven by a hydrostatic drive powered by a combustion engine and having rear first and second castor wheels. A second type of transport vehicle includes a first portion having first wheels articulated to a second portion having rear wheels driven by a hydrostatic drive powered by a combustion engine. Both types require a worker to walk behind the conventional transport vehicle and require turning the conventional transport vehicle by twisting their bodies. Hydrostatic drives of conventional transport vehicles require relatively high capital expenditures and relatively high maintenance. However, roofers are notorious for neglecting maintenance and maximizing operation of conventional transport vehicles. The lack of maintenance results in breakdown, requiring dismantling components of the conventional transport vehicle for repair, and removing the transport vehicle from service for an extended period of time.

Thus, a need exists for a motorized transport vehicle which overcomes the shortcomings of conventional transport vehicles, namely, which is less capital intensive to fabricate, requires less maintenance, which reduces downtime for repair, and which allows the worker to ride on the motorized transport vehicle.

### SUMMARY

This need and other problems in the field of handling materials on flat roof surfaces are solved by providing a motorized transport vehicle. Specifically, a motorized, drive wheel is connected to a single boom pivotably mounted to a body having rotatable front wheels. A power supply for the motorized, drive wheel is carried by the body. In certain aspects, the motorized, drive wheel includes an electric motor, and the power supply includes batteries and a generator electrically connected to the batteries for charging the batteries.

In aspects as shown, the body includes first and second frames each including a first leg extending parallel to and spaced from the surface, a second leg extending at an obtuse angle from the first leg and away from the surface, and a third leg extending at an obtuse angle from the second leg and away from the first leg. A handle extends between free ends of the third legs of the first and second frames. The rotatable front wheels are connected to the first legs of the first and second frames. A work piece is removably attached to the body.

A sulky is removably secured to the drive wheel and is pivotably mounted together with the drive wheel to the body about a pivot axis. In aspects as shown, a sulky bracket is non-rotatably slideably received in a tube forming the single boom to which the drive wheel is attached.

The body includes cross bars, cross beams, cross pieces, and the like for supporting shelf plates for the batteries and the generator.

The workpiece can be removably supported across horizontal supports and/or by pivot extrusions removably received in attachment brackets while support extrusions abut with the horizontal supports.

The following detailed description of illustrative embodiments will become clearer in connection with the drawings.

### DESCRIPTION OF THE DRAWINGS

The illustrative embodiments may best be described by reference to the accompanying drawings where:

FIG. 1 is a rear perspective view of a motorized transport vehicle.

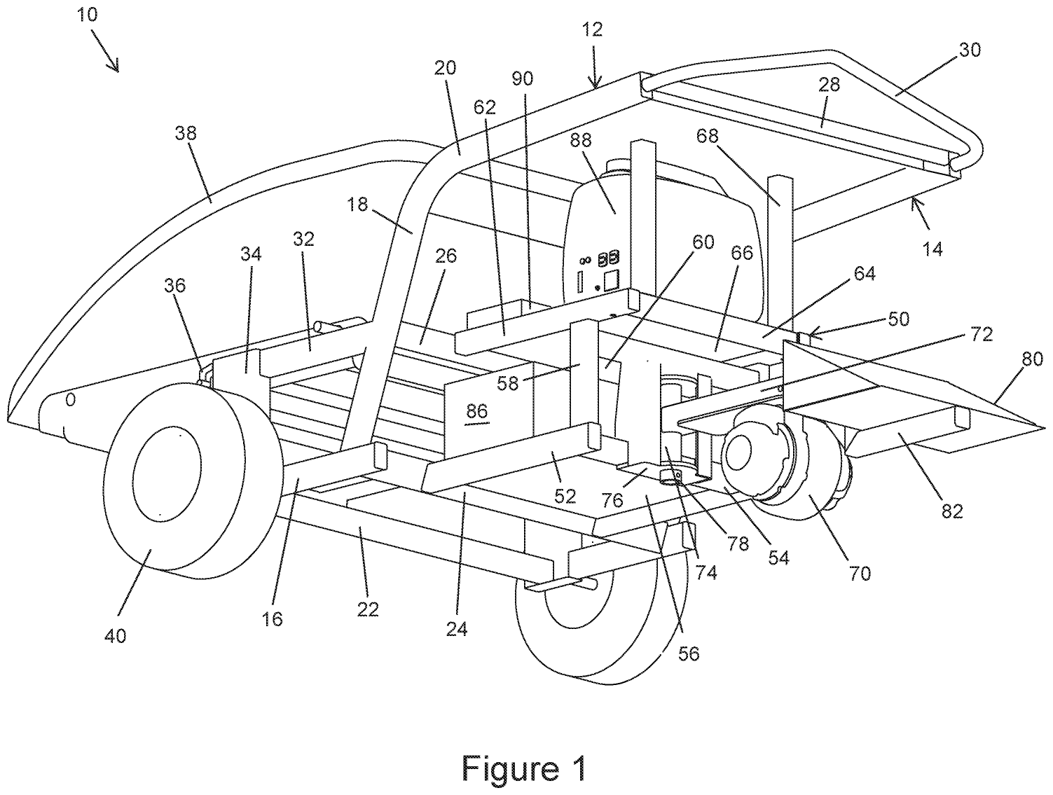

FIG. 2 is an exploded, perspective view of the motorized transport vehicle of FIG. 1.

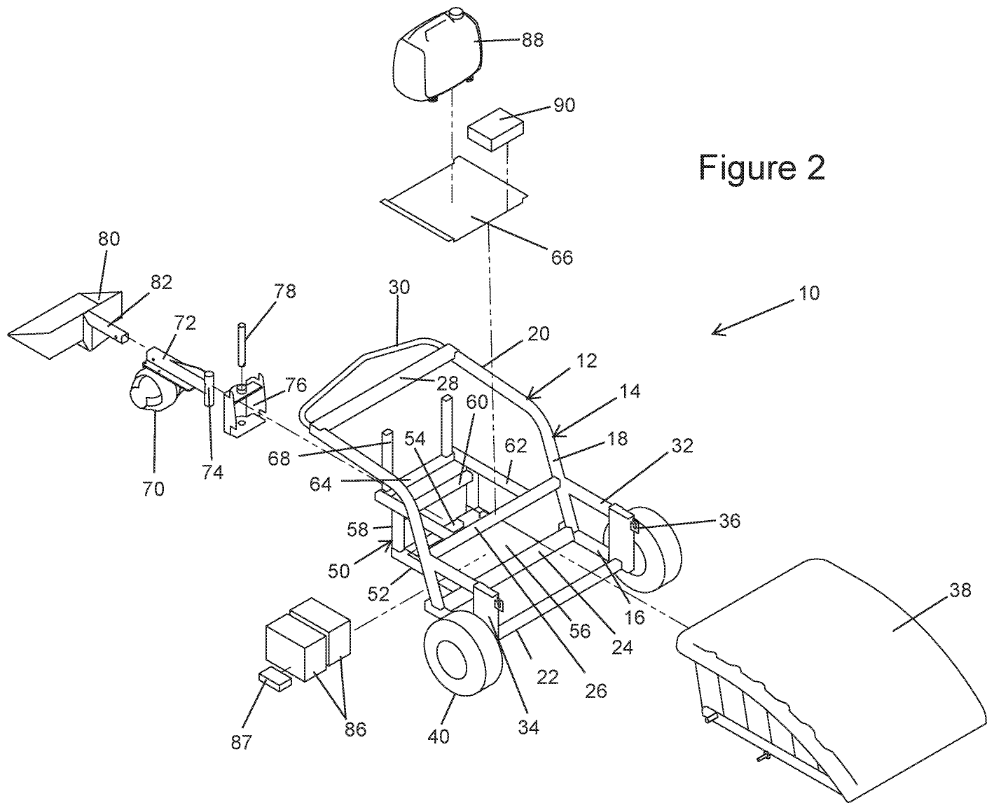

All figures are drawn for ease of explanation of the basic teachings only; the extensions of the figures with respect to number, position, relationship, and dimensions of the parts to form the illustrative embodiments will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “top”, “bottom”, “first”, “second”, “forward”, “rearward”, “reverse”, “front”, “back”, “height”, “width”, “length”, “end”, “side”, “horizontal”, “vertical”, and similar terms are used herein, it should be understood that these terms have reference only to the structure shown in the drawings as it would appear to a person viewing the drawings and are utilized only to facilitate describing the illustrative embodiments.

### DESCRIPTION OF THE ILLUSTRATIVE EMBODIMENTS

A transport vehicle for movement on a surface is shown in the drawings and generally designated 10. Vehicle 10 generally includes a body 12 formed by first and second frames 14 of a generally Z-shape. Specifically, frames 14 include first legs 16 extending generally horizontally and parallel to the surface, second legs 18 extending at an obtuse angle from first legs 16 and away from the surface, and third legs 20 extending at an obtuse angle from second legs 18 and away from the first legs 16. Cross bars 22, 24, 26 and 28 extend between frames 14 at the free ends of first legs 16, at the interconnection of first and second legs 16 and 18, intermediate the ends of second legs 18, and at the free ends of third legs 20, respectively, with cross bars 22, 24, 26 and 28 being in spaced parallel relation to each other and the surface. A handle 30 extends generally arcuately between the free ends of third legs 20. First and second horizontal supports 32 extend generally horizontally and parallel to first legs 16 and the surface from second legs 18 at the interconnections with cross bar 26. First and second horizontal supports 32 terminate in vertical supports 34 extending generally perpendicularly to first legs 16, cross bar 22, horizontal supports 32, and the surface. Suitable provisions, shown as attachment brackets 36 extending from vertical supports 34 away from horizontal supports 32, are provided to removably attach a work piece, shown as a pivotal tray 38 for holding materials, for support by cross bars 22, 24 and 26, legs 16 and 18, and supports 32 and 34 of body 12. Wheels 40 are suitably rotatably mounted about a wheel axis to body 12 generally at the interconnection of legs 16, cross bar 22, and vertical supports 34.

Body 12 further includes a framework 50 extending rearwardly from cross bar 24, behind legs 18 and below legs 20. Particularly, framework 50 includes first and second beams 52 extending rearwardly from cross bar 24 generally horizontally and parallel to and spaced from legs 18 and the surface, and inwardly, intermediate, and spaced from legs 18. A cross piece 54 extends generally perpendicularly between frame beams 52 generally horizontally and parallel to the surface. A shelf plate 56 is positioned on frame beams 52 and cross piece 54 generally horizontally and parallel to and spaced from the surface. Vertical posts or braces 58 extend generally perpendicular to frame beams 52 and parallel to and spaced inwardly of planes defined by frames 14. A cross piece or brace 60 extends generally perpendicularly between vertical posts or braces 58 intermediate their ends. Third and fourth support beams 62 extend rearwardly from cross bar 26 generally horizontally and parallel to the surface, inwardly and spaced from legs 18. Vertical posts or braces 58 generally terminate in support beams 62. A cross piece or frame brace 64 extends generally perpendicularly between support beams 62 generally horizontally and parallel to the surface. A shelf plate 66 is positioned on support beams 62 and cross piece or frame brace 64 spaced from and parallel to shelf plate 56 and the surface. Vertical posts 68 extend generally perpendicular from cross piece or frame brace 64 inwardly of and generally perpendicular to support beams 62.

Vehicle 10 generally includes a motorized drive wheel 70 which can be of a conventional form including a cylindrical rim arranged concentrically around a motor which is typically electrical and which drives the cylindrical rim to rotate about a drive axis around the motor. Motorized drive wheel 70 is mounted to a single boom 72 shown including the form of a tube of a non-circular, square cross section. A first hinge bracket 74 is mounted to the opposite end of boom 72. A second hinge bracket 76 is mounted to body 12 and in particular is mounted between cross pieces 54 and 60 intermediate and spaced inwardly of frame and support beams 52 and 62 and vertical posts or braces 58. A pivot pin 78 defining a pivot axis extends through hinge brackets 74 and 76 and pivotably mounts boom 72 to body 12, with pivot pin 78 extending generally perpendicular to the surface and boom 72 movable in a plane parallel to the surface. Thus, drive wheel 70 motorized to be rotatable about the drive axis parallel to and spaced from the surface is pivotably mounted to body 12 about the pivot axis extending generally perpendicular to the surface, with hinge bracket 76 intermediate the wheel axis of wheels 40 and drive wheel 70.

Transport vehicle 10 further includes a sulky 80 removably attached to boom 72 and removably secured to motorized drive wheel 70. In the form shown, sulky 80 is supported above the surface such as by a bracket 82 having cross sections slideably received in the tube of the single boom 72. Thus, sulky 80 and motorized drive wheel 70 are pivotably mounted together to body 12 about the pivot axis

Transport vehicle 10 includes a power supply for motorized wheel 70. In the form shown, batteries 86 are electrically connected to the electric motor of motorized wheel 70 and are supported upon shelf plate 56 with a charger 87. A generator 88, which can be of the fuel combustion type, is electrically connected to batteries 86 and is supported upon shelf plate 66 with a controller 90. The charger 87 receives power from generator 88 and supplies power to batteries 86, constantly monitoring voltage of the batteries 86 and adjusting their charging accordingly.

In operation, transport vehicle 10 can be removably attached to a desired work piece, with 100% of the work piece carried by transport vehicle 10. In some cases, transport vehicle 10 is used without accessories, such as placing long heaving rolls of material, lumber and the like across horizontal supports 32 for transport to working locations on the roof surface. In other cases, transport vehicle 10 is used with accessories, such as pivotal tray 38 of different sizes for transporting refuse (tear-off), tools, materials, adhesives, and the like on the roof surface to and from disposal areas, landing zones, and working locations. As an example, pivot extrusions extending from tray 38 are removably, slideably received in the attachment brackets 36 while support extrusions extending from tray 38 abut with horizontal supports 32, with tray 38 located intermediate supports 32 and 34. Other accessories include, but are not limited to, gravel spreaders for dispensing gravel on the roof surface.

To move the desired work piece, a worker grips handle 30 and activates the motor of motorized wheel 70 to move transport vehicle 10 on the surface. By twisting their body, motorized wheel 70 and single boom 72 pivots about pivot pin 78 relative to body 12 and wheels 40 rotatably mounted thereto. Thus, transport vehicle 10 and the work piece attached thereto turn while moving on the surface. The worker can be walking on the surface or can be standing on sulky 80 when twisting their body. It should be appreciated that in the form illustrated, vehicle 10 is configured to pivot body 12 relative to motorized wheel 70 solely by manually pushing by the worker and without assistance such as mechanically electrically, or hydraulically.

It can be appreciated that the worker can ride on transport vehicle 10 by standing on sulky 80, and it is not necessary to walk behind transport vehicle 10 as was required in conventional transport vehicles. When equipped with sulky 80, transport vehicle 10 can be utilized for towing including, but not limited to, trailers for transporting heavy and bulky goods, such as decking materials, roll carriers, power jacks, hand-powered fork lifts, and other mechanisms for use on the roof surface. In this regard, prior conventional transport vehicles could not be safely used for towing as workers had to walk behind the transport vehicle.

Transport vehicle 10 as shown includes motorized wheel 70, batteries 86, and generator 88 which are purchased and easily replaceable components. Thus, the capital expenditures for transport vehicle 10 shown is substantially less than capital expenditures for hydrostatic drives and combustion engines of conventional transport vehicles. Further, the requirements for maintenance of motorized wheel 70 is substantially less than for hydrostatic drives of conventional transport vehicles. Additionally, motorized wheel 70, batteries 86 and generator 88 can be easily removed and replaced if maintenance is required to reduce the downtime of transport vehicle 10 compared to the downtime for repair of components of conventional transport vehicles.

Thus, since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Vehicle for transporting materials on a surface comprising, in combination: a body including first and second frames, with each frame including a first leg extending generally parallel to and spaced from the surface, a second leg extending at an obtuse angle from the first leg and away from the surface, and a third leg extending at an obtuse angle from the second leg and away from the first leg, with the body further including a handle extending between free ends of the third legs of the first and second frames; first and second wheels rotatably mounted about a wheel axis and on opposite sides of the body and connected to the first legs with the wheel axis being parallel to and spaced from the surface; means for removably attaching a work piece including the materials to the body; a drive wheel motorized to be rotatable about a drive axis parallel to and spaced from the surface, with the drive wheel pivotably mounted to the body about a pivot axis extending generally perpendicular to the surface; and a power supply for the drive wheel positioned in the body.

2. The vehicle of claim 1, further comprising, in combination: a sulky removably secured to the drive wheel, with the sulky and the drive wheel pivotably mounted together to the body about the pivot axis.

3. The vehicle of claim 2, further comprising, in combination: a first hinge bracket; a pivot pin extending through the first hinge bracket and the body along the pivot axis; and a boom extending from the first bracket generally perpendicular to the pivot axis, with the sulky removably attached to the boom opposite to the first hinge bracket, and with the drive wheel connected to the boom.

4. The vehicle of claim 3, wherein the boom is a tube of a non-circular cross section; and wherein the sulky includes a sulky bracket non-rotatably slideably received in the tube.

5. The vehicle of claim 4, wherein the power supply includes batteries and a generator, with the drive wheel including an electric motor, with the batteries configured to be electrically connected to the electric motor, and with the generator configured to be electrically connected to the batteries.

6. The vehicle of claim 5, further comprising, in combination: a second hinge bracket, with the pivot pin extending through the first and second hinge brackets, with the body further including a cross piece extending parallel to and spaced from the drive axis and the surface and a cross brace extending parallel to and spaced from the cross beam, the drive axis, and the surface, with the second hinge bracket extending between and connected to the cross piece and the cross brace, and with the second hinge bracket intermediate the wheel axis and the drive wheel.

7. The vehicle of claim 6, with the body further including a cross bar extending between the first legs of the first and second frames, with the cross bar intermediate the wheel axis and the cross piece; and a shelf plate extending between the cross bar and the cross piece parallel to and spaced from the surface, with the batteries supported upon the shelf plate.

8. The vehicle of claim 7, with the body further including another cross bar extending between the second legs of the first and second frames and extending parallel to and spaced from the wheel axis and the surface; first and second support beams extending from the other cross bar spaced from and parallel to the surface and the first legs of the first and second frames, with the first and second support beams located intermediate and spaced from the first legs of the first and second frames; and another shelf plate extending between the first and second support beams spaced from and parallel to the surface and the shelf plate, with the generator supported upon the other shelf plate.

9. The vehicle of claim 8, with the body further including frame beams extending between the cross brace and the cross piece; and vertical braces extending between the frame beams and the first and second support beams, with the cross brace extending between the vertical braces generally parallel to and spaced from the surface and the cross piece.

10. The vehicle of claim 9, with the body further including a frame brace extending between the first and second support beams spaced from and parallel to the other cross bar and the surface; and vertical posts extending from the frame brace opposite to the cross piece.

11. The vehicle of claim 10, wherein the removably attaching means is configured to carry 100% of the work piece.

12. The vehicle of claim 11, wherein the removably attaching means comprises a horizontal support extending from the second leg parallel to and spaced from the first leg of each of the first and second frames; and a vertical support extending between the first leg and the horizontal support, with the working piece extending between the horizontal supports of the first and second frames.

13. The vehicle of claim 12, wherein the removably attaching means comprises attachment brackets extending from the vertical supports away from the horizontal supports and configured to slideably receive pivot extrusions on the work piece, with the horizontal supports configured to abut against support extrusions on the work piece.

14. The vehicle of claim 1, wherein the removably attaching means is configured to carry 100% of the work piece.

15. The vehicle of claim 14, wherein the removably attaching means comprises a horizontal support extending from the second leg parallel to and spaced from the first leg of each of the first and second frames; and a vertical support extending between the first leg and the horizontal support, with the working piece extending between the horizontal supports of the first and second frames.

16. The vehicle of claim 15, wherein the removably attaching means comprises attachment brackets extending from the vertical supports away from the horizontal supports and configured to slideably receive pivot extrusions on the work piece, with the horizontal supports configured to abut against support extrusions on the work piece.

17. The vehicle of claim 1, wherein the power supply includes batteries and a generator, with the drive wheel including an electric motor, with the batteries configured to be electrically connected to the electric motor, and with the generator configured to be electrically connected to the batteries.

18. The vehicle of claim 17, wherein the body further includes a cross piece extending parallel to and spaced from the drive axis and the surface; a cross bar extending between the first legs of the first and second frames, with the cross bar intermediate the wheel axis and the cross piece; and a shelf plate extending between the cross bar and the cross piece parallel to and spaced from the surface, with the batteries supported upon the shelf plate.

19. The vehicle of claim 18, with the body further including another cross bar extending between the second legs of the first and second frames and extending parallel to and spaced from the wheel axis and the surface; first and second support beams extending from the other cross bar spaced from and parallel to the surface and the first legs of the first and second frames, with the first and second support beams located intermediate and spaced from the first legs of the first and second frames; and another shelf plate extending between the first and second support beams spaced from and parallel to the surface and the shelf plate, with the generator supported upon the other shelf plate.

20. The vehicle of claim 19, with the body further including frame beams extending between the cross brace and the cross piece; and vertical braces extending between the frame beams and the first and second support beams, with the cross brace extending between the vertical braces generally parallel to and spaced from the surface and the cross piece.
